(19) United States
(12) Patent Application Publication
(10) Pub. No.: US 2012/0274518 A1
(43) Pub. Date: Nov. 1, 2012

(54) MULTI-BAND WIRELESS TERMINALS WITH METAL BACKPLATES AND MULTI-BAND ANTENNAE, AND MULTI-BAND ANTENNA SYSTEMS WITH METAL BACKPLATES AND MULTI-BAND ANTENNAE

(76) Inventor: Zhinong Ying, Lund (SE)

(21) Appl. No.: 13/496,718

(22) PCT Filed: Apr. 5, 2011
(86) PCT No.: PCT/IB2011/000738

§ 371 Date: Jul. 18, 2012

(51) Int. Cl. H01Q 5/01; H01Q 1/24

(52) U.S. Cl. 343/702; 343/700 MS

(57) ABSTRACT

A multi-band antenna system may include a unitary metal backplate. The unitary metal backplate may include a notch. The antenna system may also include a first antenna that may be at least partially covered by a non-metal cover. The first antenna may be on an end of the unitary metal backplate, and may be configured to resonate in a first frequency band in response to a first electromagnetic radiation. The first frequency band may include includes cellular frequencies. The antenna system may also include a second antenna that may be recessed in the notch. The second antenna may be configured to resonate in a second frequency band in response to a second electromagnetic radiation.

### FIELD OF THE INVENTION

The present invention generally relates to the field of communications and, more particularly, to antennas and wireless terminals incorporating the same.

### BACKGROUND

Wireless terminals may operate in multiple frequency bands to provide operations in multiple communications systems. For example, many cellular radiotelephones are designed for operation in Global System for Mobile Communications (GSM) and Wideband Code Division Multiple Access (WCDMA) modes at nominal frequencies of 850 Megahertz (MHz), 900 MHz, 1800 MHz, 1900 MHz, and/or 2100 MHz.

Achieving effective performance in multiple frequency bands (i.e., “multi-band”) may be difficult. For example, contemporary wireless terminals are increasingly including more circuitry and larger displays and keypads/keyboards within small housings. As a consequence, there has been increased use of semi-planar antennas, such as a multi-branch inverted-F antenna, that may occupy a smaller space within a terminal housing. Moreover, wireless terminals may include multiple antennas to accommodate demand for multiple frequency bands and multiple systems. Constraints on the available space and locations for the antennas can negatively affect antenna performance.

### SUMMARY

Some embodiments of the present invention include a multi-band wireless communications terminal. The multi-band wireless communications terminal may include a unitary metal backplate that covers a multi-band transceiver circuit that is configured to provide communications for the multi-band wireless communications terminal via a plurality of frequency bands. The multi-band wireless communications terminal may also include a notch in a perimeter of the unitary metal backplate. The multi-band wireless communications terminal may additionally include a display opposing the unitary metal backplate such that the multi-band transceiver circuit is between the unitary metal backplate and the display. The multi-band wireless communications terminal may further include a first antenna that is at least partially covered by a non-metal cover. The first antenna may be on an end of the unitary metal backplate and may be configured to resonate in a first frequency band that is within the plurality of frequency bands in response to a first electromagnetic radiation. The multi-band wireless communications terminal may also include a second antenna that is recessed in the notch between the display and the unitary metal backplate. The second antenna may be configured to resonate in a second frequency band that is within the plurality of frequency bands in response to a second electromagnetic radiation.

In some embodiments, the non-metal cover of the multi-band wireless communications terminal includes plastic.

In some embodiments, the notch of the multi-band wireless communications terminal is configured to provide access to user-activated buttons that are configured to control the multi-band wireless communications terminal. The user-activated buttons may include buttons configured to control at least one of volume, power, and imaging device functions.

In some embodiments, the notch of the multi-band wireless communications terminal is configured to emit communications from the second antenna. In some embodiments, a width of the notch is approximately 1-2 millimeters and a length of the notch is approximately 4-8 centimeters.

In some embodiments, the notch of the multi-band wireless communications terminal is configured to provide access to at least one of a Universal Serial Bus (USB) port and a device charging port.

In some embodiments, the notch of the multi-band wireless communications terminal includes a tunable LC loading.

In some embodiments, the first and second antennas of the multi-band wireless communications terminal are configured such that a polarization of the second antenna is orthogonal to a polarization of the first antenna.

In some embodiments, the multi-band wireless communications terminal includes a second notch in the perimeter of the unitary metal backplate, and a third antenna recessed in the second notch between the display and the unitary metal backplate. The third antenna may be configured to resonate in a third frequency band that is within the plurality of frequency bands in response to a third electromagnetic radiation. Additionally, the second and third antennas may be separated along the perimeter of the unitary metal backplate by metal. Moreover, the third antenna may be on a second end of the unitary metal backplate that is opposite the first antenna.

In some embodiments, the first antenna of the multi-band wireless communications terminal includes a planar inverted-F antenna.

In some embodiments, the unitary metal backplate of the multi-band wireless communications terminal includes a void that is sized for optics of an imaging device.

In some embodiments, the first frequency band includes cellular frequencies and the third frequency band includes non-cellular frequencies.

In some embodiments, the unitary metal backplate of the multi-band wireless communications terminal partially covers the first antenna such that a portion of the first antenna is between the display and the unitary metal backplate.

In some embodiments, the first antenna of the multi-band wireless communications terminal includes a first multi-band antenna and the second antenna includes a second multi-band antenna.

A multi-band antenna system according to some embodiments includes a unitary metal backplate that includes a face, first and second sidewalls, and first and second ends. The antenna system may also include a first notch in the first sidewall of the unitary metal backplate. The antenna system may additionally include a second notch in one of the second sidewall of the unitary metal backplate and the second end of the unitary metal backplate. The antenna system may additionally include a first antenna that is at least partially covered by a non-metal cover. The first antenna may be on the first end of the unitary metal backplate, and the first antenna may be configured to resonate in a first frequency band in response to a first electromagnetic radiation. The first frequency band may include cellular frequencies. The antenna system may also include a second antenna that is recessed in the first notch. The second antenna may be configured to resonate in a second frequency band in response to a second electromagnetic radiation. Additionally, the antenna system may include a third antenna that is recessed in the second notch. The third antenna may be configured to resonate in a third frequency band in response to a third electromagnetic radiation, and at least one of the second and third frequency bands may include non-cellular frequencies.

In some embodiments, the first antenna of the antenna system includes a first multi-band antenna, and one of the second and third antennas includes a second multi-band antenna.

In some embodiments, the face of the unitary metal backplate of the antenna system partially covers the first antenna.

Other devices and/or systems according to embodiments of the invention will be or become apparent to one with skill in the art upon review of the following drawings and detailed description. It is intended that all such additional devices and/or systems be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

FIG. 1 is a schematic illustration of a wireless communications network that provides service to wireless terminals according to some embodiments of the present invention.

FIG. 2 is a block diagram illustrating multi-band wireless terminals according to some embodiments of the present invention.

FIGS. 3A and 3B illustrate front and rear views, respectively, of a multi-band wireless terminal according to some embodiments of the present invention.

FIG. 4 illustrates a side view of a multi-band wireless terminal according to some embodiments of the present invention.

FIG. 5 illustrates a unitary metal backplate including a notch according to some embodiments of the present invention.

FIG. 6 illustrates a wireless terminal including an antenna recessed in a notch in a unitary metal backplate according to some embodiments of the present invention.

FIG. 7 illustrates a unitary metal backplate including a notch in an edge of a unitary metal backplate perimeter according to some embodiments of the present invention.

FIG. 8 illustrates a unitary metal backplate including a notch between edges of a unitary metal backplate perimeter according to some embodiments of the present invention.

FIG. 9 illustrates a unitary metal backplate including a void sized for optics of an imaging device and including structures within a notch according to some embodiments of the present invention.

FIG. 10 illustrates a unitary metal backplate including structures within a notch according to some embodiments of the present invention.

FIG. 11 illustrates a unitary metal backplate including antenna feeding and loading structures according to some embodiments of the present invention.

FIG. 12 illustrates a unitary metal backplate including a plurality of notches according to some embodiments of the present invention.

FIG. 13 illustrates a wireless terminal including a unitary metal backplate that includes a plurality of notches according to some embodiments of the present invention.

FIG. 14 illustrates a face, sidewalls, and ends of a unitary metal backplate according to some embodiments of the present invention.

### DETAILED DESCRIPTION OF EMBODIMENTS ACCORDING TO THE PRESENT INVENTION

The present invention now will be described more fully with reference to the accompanying drawings, in which embodiments of the invention are shown. However, the present application should not be construed as limited to the embodiments set forth herein. Rather, these embodiments are provided so that this disclosure will be thorough and complete, and to fully convey the scope of the embodiments to those skilled in the art. Like reference numbers refer to like elements throughout.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to another element, it can be directly coupled, connected, or responsive to the other element, or intervening elements may also be present. In contrast, when an element is referred to as being “directly coupled,” “directly connected,” or “directly responsive” to another element, there are no intervening elements present. As used herein the term “and/or” includes any and all combinations of one or more of the associated listed items.

Spatially relative terms, such as “above”, “below”, “upper”, “lower” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

It will be understood that, although the terms first, second, etc. may be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which these embodiments belong. It will be further understood that teens, such as those defined in commonly used dictionaries, should be interpreted as having a meaning that is consistent with their meaning in the context of the relevant art and will not be interpreted in an idealized or overly formal sense unless expressly so defined herein.

For purposes of illustration and explanation only, various embodiments of the present invention are described herein in the context of multi-band wireless communication terminals (“wireless terminals”/“mobile terminals”/“terminals”) that are configured to carry out cellular communications (e.g., cellular voice and/or data communications) in more than one frequency band. It will be understood, however, that the present invention is not limited to such embodiments and may be embodied generally in any device and/or system that includes a multi-band Radio Frequency (RF) antenna that is configured to transmit and receive in two or more frequency bands.

Embodiments of the present invention arise from the realization that wireless terminals may not include sufficient space and locations for antennas covering multiple bands and multiple systems. For example, some embodiments of the wireless terminals described herein may cover several frequency bands, including such frequency bands as 700-800 MHz, 824-894 MHz, 880-960 MHz, 1710-1880 MHz, 1820-1990 MHz, 1920-2170 MHz, 2300-2400 MHz, and 2500-2700 MHz. As such, as used herein, the term “multi-band” can include, for example, operations in any of the following bands: Advanced Mobile Phone Service (AMPS), ANSI-136, GSM, General Packet Radio Service (GPRS), enhanced data rates for GSM evolution (EDGE), Digital Communications Services (DCS), Personal Digital Cellular (PDC), Personal Communications Services (PCS), CDMA, wideband-CDMA, CDMA2000, and/or Universal Mobile Telecommunications System (UMTS) frequency bands. Other bands can also be used in embodiments according to the invention. Also, some embodiments may be compatible with Long Term Evolution (LTE) and/or High Speed Packet Access (HSPA) standards. Some embodiments may include multiple antennas, such as a secondary antenna for Multiple Input Multiple Output (MIMO) and diversity applications. Some embodiments may provide coverage for non-cellular frequency bands such as GPS and WLAN frequency bands. Additionally, embodiments of the present invention arise from the realization that a unitary metal backplate for wireless terminals may provide a design that is desirable to users. Accordingly, embodiments described herein include metal backplates that include multi-band antennas and wireless terminals including such metal backplates.

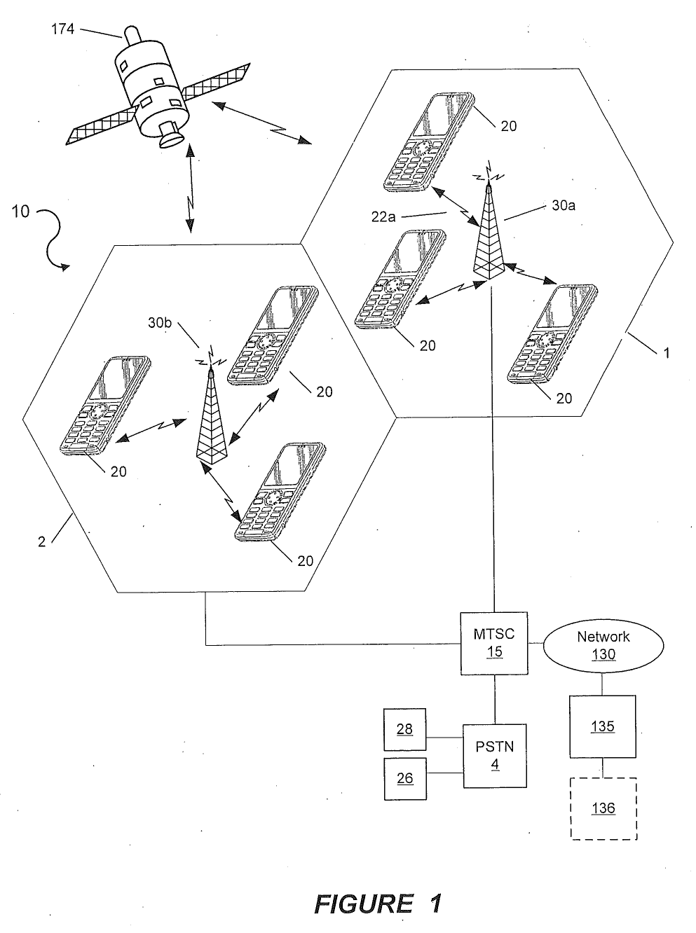

FIG. 1 is a diagram that illustrates a wireless communications network (network) 10 that supports communications in which wireless terminals 20 can be used. Networks 10 are commonly employed to provide voice and data communications to subscribers using, for example, the standards discussed above. According to FIG. 1, the wireless terminals 20 can communicate with each other via a Mobile Telephone Switching Center (MTSC) 15. The wireless terminals 20 can also communicate with other terminals, such as terminals 26, 28, via a Public Service Telephone Network (PSTN) 4, commonly referred to as a “landline” network, that is coupled to the network 10. As also shown in FIG. 1, the MTSC 15 is coupled to a computer server 135 supporting a location service 136 (i.e., a location server) via a network 130, such as the Internet.

The network 10 is organized as cells 1-2 that collectively can provide service to a geographic region. In particular, each of the cells can provide service to associated sub-regions included in the geographic region covered by the network 10. More or fewer cells can be included in the network 10, and the coverage area for the cells may overlap. Each of the cells may include an associated base station 30a-b. The base stations 30a-b can provide wireless communications between each other and the wireless terminals 20 in the associated geographic region.

Each of the base stations 30a-b can transmit/receive data to/from the wireless terminals 20 over an associated control channel. For example, the base station 30a in cell 1 can communicate with one of the wireless terminals 20 in cell 1 over the control channel 22a. The control channel 22a can be used, for example, to page the wireless terminal 20 in response to calls directed thereto or to transmit traffic channel assignments to the wireless terminal 20 over which a call associated therewith is to be conducted.

The wireless terminals 20 may also be capable of receiving messages from the network 10 over the respective control channel 22. In some embodiments according to the invention, the wireless terminals receive Short Message Service (SMS), Enhanced Message Service (EMS), Multimedia Message Service (MMS), and/or Smartmessaging™ formatted messages.

A Global Positioning System (GPS) 174 can provide GPS information to the geographic region including cells 1-2 so that the wireless terminals 20 may determine location information. The network 10 may also provide network location information as the basis for the location information applied by the wireless terminals. In addition, the location information may be provided directly to the server 135 rather than to the wireless terminals 20 and then to the server 135.

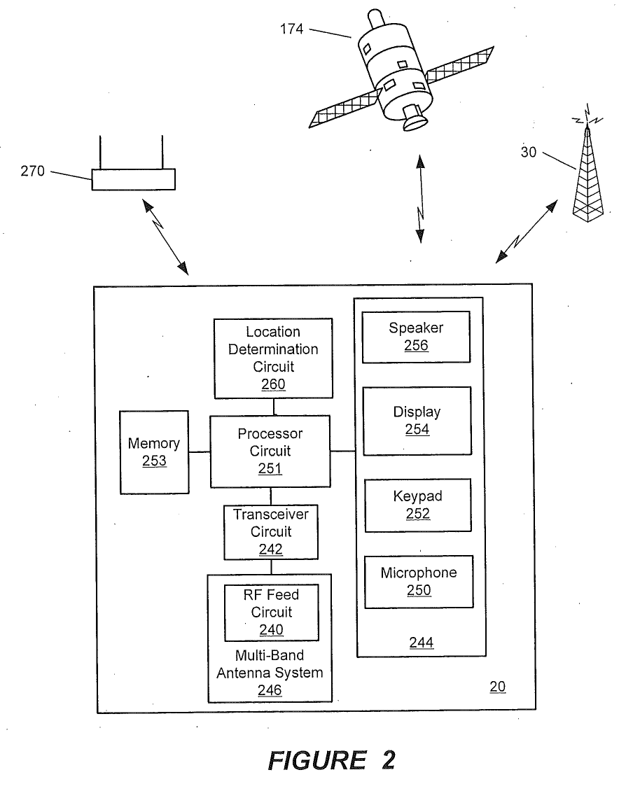

FIG. 2 is a block diagram illustrating multi-band wireless terminals 20 according to some embodiments. As illustrated in FIG. 2, the wireless terminal 20 includes a transceiver circuit 242 that is operative to transmit and receive radio frequency communication signals to the network 10 via a multi-band antenna system 246. The multi-band antenna system 246 may include an antenna feed circuit and one or more antennas. The antenna feed circuit may be an RF feed circuit 240, and may be coupled to one or more antenna feeding structures.

A transmitter portion of the transceiver 242 converts information, which is to be transmitted by the wireless terminal 20, into electromagnetic signals suitable for radio communications. A receiver portion of the transceiver 242 demodulates electromagnetic signals, which are received by the wireless terminal 20 from the network 10 to provide the information contained in the signals in a format understandable to a user of the wireless terminal 20.

A user interface 244 of the wireless terminal 20 may include a variety of components, such as a display 254, a keypad 252, a speaker 256, and a microphone 250, operations of which are known to those of skill in the art. It will be understood that the functions of the keypad 252 and the display 254 can be provided by a touch screen through which the user can view information, such as computer displayable documents, provide input thereto, and otherwise control the wireless terminal 20.

A processor circuit 251 provides for overall operation of the wireless terminal 20, including coordination of communications via the transceiver circuit 242, the user interface 244, and other components included in the wireless terminal 20. For example, the processor circuit 251 can provide communications signals to the transceiver circuit 242 when the user speaks into the microphone 250 and can receive communications signals from the transceiver 242 for reproduction of audio through the speaker 256. The processor circuit 251 can generate characters for display on the display 254. For example, the processor circuit 251 can generate numbers for display when the user enters a telephone number on the keypad 252. The characters can also be generated by a character generator circuit (not shown).

The processor circuit 251 may be configured to communicate data over the transceiver 242 according to one or more communication protocols, such as one or more cellular communication protocols and/or other communication protocols. The cellular communication protocols may include, but are not limited to, those corresponding to the frequency bands described herein. The other communication protocols may include, but are not limited to, Bluetooth, Radio Frequency Identification (RFID), GPS, and/or Wireless Local Area Network (WLAN) (e.g., 802.11a, 802.11b, 802.11e, 802.11g, and/or 802.11i). For example, the wireless terminal 20 may communicate with a local wireless network 270 (through a local wireless interface circuit not shown). In some embodiments according to the invention, the local wireless network 270 is a WLAN compliant network. In some other embodiments according to the invention, the local wireless network 270 is a Bluetooth compliant interface.

The processor circuit 251 may be implemented using a variety of hardware and software. For example, operations of the processor circuit 251 may be implemented using special-purpose hardware, such as an Application Specific Integrated Circuit (ASIC) and programmable logic devices such as gate arrays, and/or software or firmware running on a computing device such as a microprocessor, microcontroller, or digital signal processor (DSP). The processor circuit 251 may provide digital signal processing operations such as scanning for an acceptable control channel, camping on a control channel (including maintaining synchronization with the base station that communicates with the wireless terminal 20), Voice Activated Dialing (VAD) services, performing media operations, and the like.

The wireless terminal 20 may include a location determination circuit 260, such as a GPS location circuit, including a GPS receiver circuit, that uses, for example, any available GPS or assisted-GPS based location approach in conjunction with the GPS satellite system 174. Assisted-GPS is defined, for example, in specification numbers 3GPP TS 04.31, 3GPP TS 03.71, and 3GPP TS 04.35.

A memory 253 can store computer program instructions that, when executed by the processor circuit 251, carry out the operations described herein and shown in the figures. The memory 253 can be non-volatile memory, such as EEPROM (flash memory), that retains the stored data while power is removed from the memory 253.

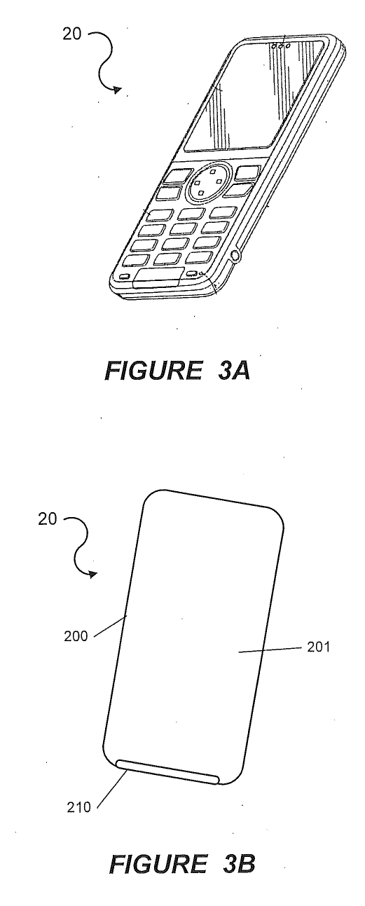

FIGS. 3A and 3B illustrate front and rear views, respectively, of the wireless terminal 20 according to some embodiments of the present invention. Accordingly, FIGS. 3A and 3B illustrate opposite sides of the wireless terminal 20. In particular, FIG. 3B illustrates an external face 201 of a unitary metal backplate 200 of the wireless terminal 20. Accordingly, the external face 201 may be visible to, and/or in contact with, the user of the wireless terminal 20. In contrast, an internal face of the unitary metal backplate 200 may face internal portions of the wireless terminal 20, such as the transceiver circuit 242. The unitary metal backplate 200 may be a contiguously-metal structure. For example, the unitary metal backplate 200 may be monolithic. In other words, at least the external face 201 of the unitary metal backplate 200 may be formed from a single piece of metal.

FIG. 3B further illustrates an antenna 210 on one end of the unitary metal backplate 200. The antenna 210 may be one of various antennas configured for wireless communications. For example, the antenna 210 may be a monopole antenna or a planar inverted-F antenna (PIFA), among others. Additionally, the antenna 210 may be a multi-band antenna and/or may be configured to communicate cellular and/or non-cellular frequencies. Moreover, the antenna 210 may be a multi-band antenna included within the multi-band antenna system 246 illustrated in FIG. 2.

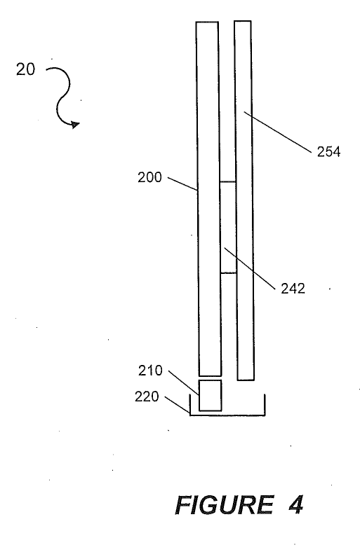

FIG. 4 illustrates a side view of the multi-band wireless terminal 20 according to some embodiments of the present invention. The multi-band transceiver circuit 242 may be between the display 254 and the unitary metal backplate 200. In some embodiments, the display 254 may be combined with the keypad 252 as a touch screen.

Referring again to FIG. 4, the antenna 210 may be at least partially covered by a non-metal cover 220. For example, the non-metal cover 220 may cover exposed portions of the antenna 210, and may contact the unitary metal backplate 200 and/or the display 254/keypad 252. As such, the antenna 210 may be enclosed against the unitary metal backplate 200 and/or the display 254/keypad 252 by the non-metal cover 220. The non-metal cover 220 may include a single non-metal material or a combination of non-metal materials. For example, the non-metal cover 220 may include plastic and/or rubber.

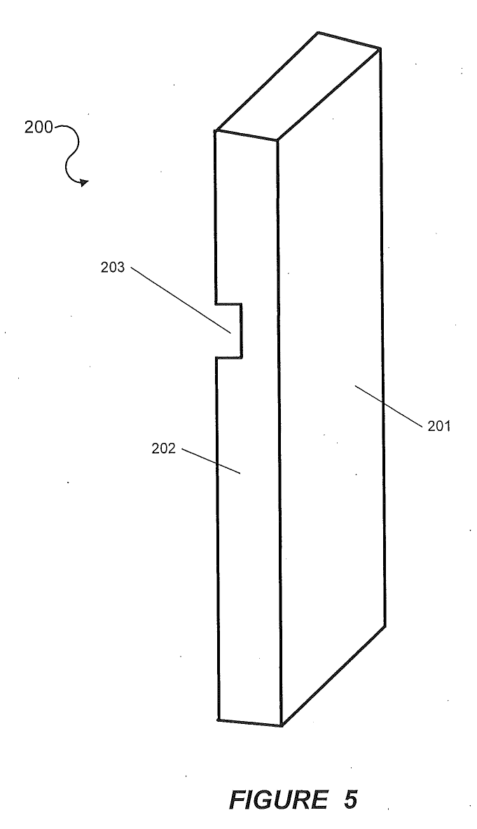

FIG. 5 illustrates the unitary metal backplate 200 according to some embodiments of the present invention. In particular, the unitary metal backplate 200 may include a perimeter 202 around the external face 201. The perimeter 202 of the unitary metal backplate 200 may include a notch 203. The perimeter 202 may circle 360 degrees around the external face 201, and the notch 203 may be anywhere along the perimeter 202. Additionally, the notch 203 may be at a variety of depths within the perimeter 202. For example, in some embodiments, the notch 203 may be directly adjacent the external face 201. Alternatively, the notch 203 may be along an edge of the perimeter 202 farthest from the external face 201, or may be anywhere in between such an edge and the external face 201. Additionally, the notch 203 may be one of a variety of geometric shapes. For example, the notch 203 may be substantially circular, rectangular, or square, among other geometric shapes.

The external face 201 and the perimeter 202 may be a single piece of metal. Alternatively, the external face 201 and the perimeter 202 may be different pieces of metal that are attached to each other substantially without gaps therebetween.

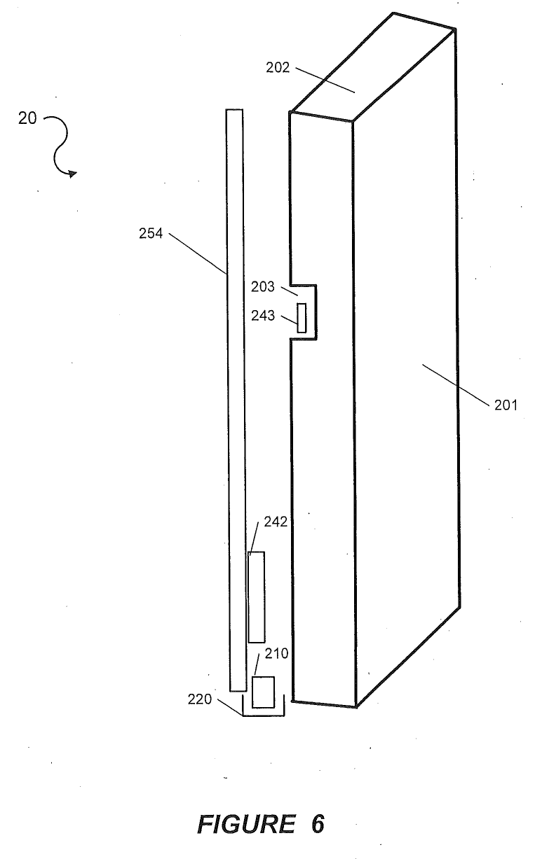

FIG. 6 illustrates the wireless terminal 20 including an antenna 243 in the notch 203 of the unitary metal backplate 200 according to some embodiments of the present invention. The antenna 243 may be recessed in the notch 203 such that the antenna 243 is between the display 254 and the external face 201 of the unitary metal backplate 200. Moreover, the antenna 243 may be included within the multi-band antenna system 246 illustrated in FIG. 2. The antenna 243 may be a multi-band antenna and/or may be configured to communicate cellular and/or non-cellular frequencies. For example, the antenna 243 may be configured to resonate in at least one of the frequency bands with which the transceiver circuit 242 is operable. In some embodiments, the antenna 210 is configured to resonate in one of the frequency bands with which the transceiver circuit 242 is operable in response electromagnetic radiation, and the antenna 243 is configured to resonate in a different one of the frequency bands in response to different electromagnetic radiation.

Still referring to FIG. 6, the unitary metal backplate 200 may partially cover the antenna 210. For example, a portion of the antenna 210 may be between the display 254 and the unitary metal backplate 200. Moreover, in some embodiments, the unitary metal backplate 200 may be recessed, and a portion of the antenna 210 may be positioned in the recess of the unitary metal backplate 200.

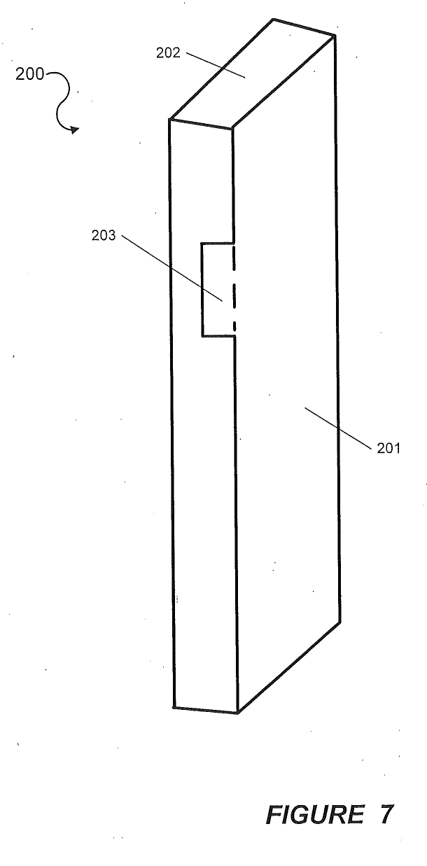

FIG. 7 illustrates the unitary metal backplate 200 including the notch 203 in an edge of the perimeter 202 according to some embodiments of the present invention. In particular, the notch 203 in FIG. 7 is directly adjacent the external face 201 of the unitary metal backplate 200. The notch 203, however, may be anywhere along the perimeter 202 and may be located at one of many distances from the external face 201.

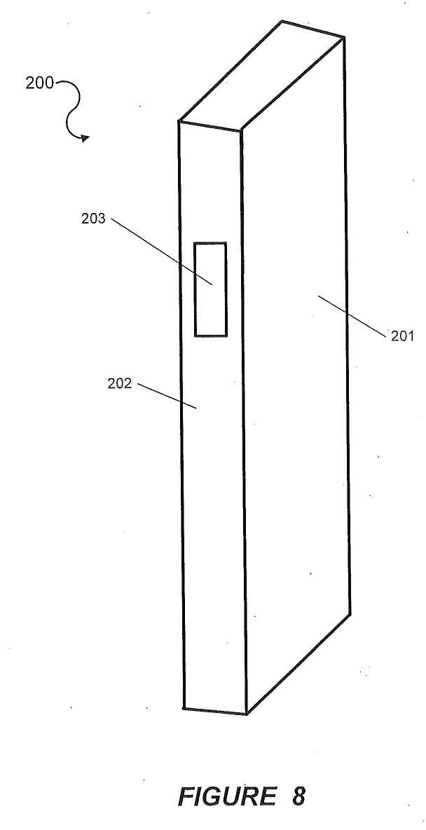

FIG. 8 illustrates the unitary metal backplate 200 including the notch 203 between edges of the perimeter 202 according to some embodiments of the present invention. In particular, the notch 203 in FIG. 8 is substantially centered between the edges of the perimeter 202. Alternatively, however, the notch 203 may be slightly or significantly off-center. For example, the notch 203 may be slightly or significantly off-center either in a direction closer to the external face 201 or in a direction farther from the external face 201.

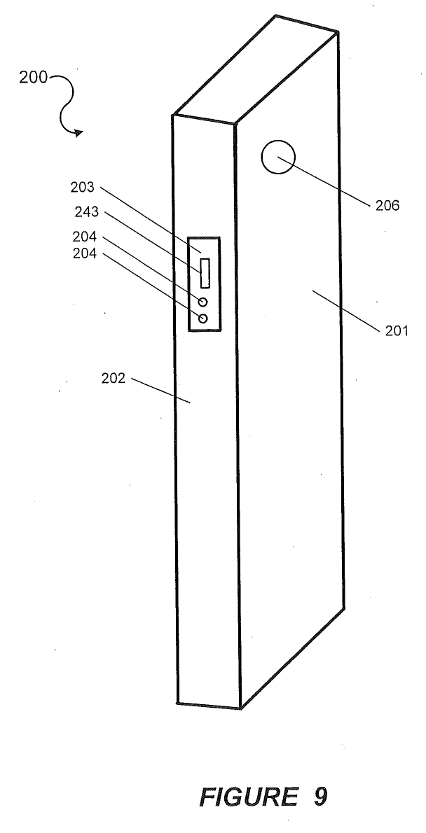

FIG. 9 illustrates the unitary metal backplate 200 including a void 206 in the external face 201 that is sized for optics of an imaging device according to some embodiments of the present invention. For example, the void 206 may be approximately the size of a lens and/or flash of the imaging device. Moreover, the void 206 may be configured to house the lens and/or flash of the imaging device. The imaging device may be one of a variety of cameras, including a still camera and/or a video camera. The external face 201 of the unitary metal backplate 200 may be fully and contiguously metal except for the void 206.

Still referring to FIG. 9, the unitary metal backplate 200 may include various structures within the notch 203 according to some embodiments. For example, the antenna 243 and/or one or more user-activated buttons 204 may be included within the notch 203. In particular, the notch 203 may sized, shaped, and/or otherwise configured to provide user access to the user-activated buttons 204. The user-activated buttons 204 may be configured to control the wireless terminal 20. For example, the user-activated buttons 204 may include one or more buttons configured to control such functions as volume, power, imaging device functions, and the like.

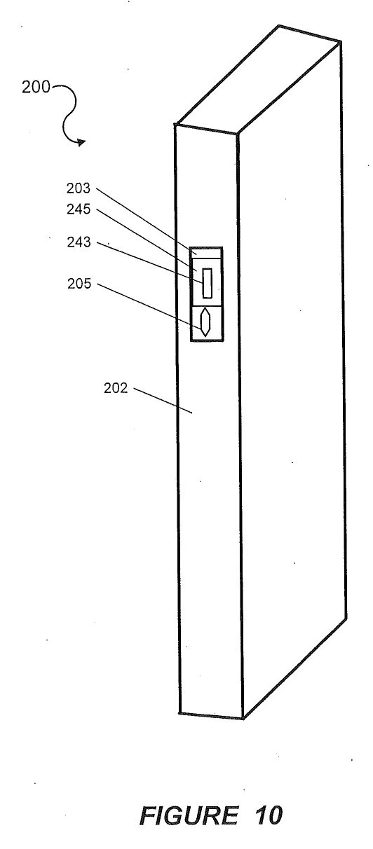

FIG. 10 illustrates the unitary metal backplate 200 including structures within the notch 203 according to some embodiments of the present invention. For example, the notch 203 may be configured to provide access to the antenna 243 and/or a device port 205. The device port 205 may include such ports as a Universal Serial Bus (USB) port, a device charging port, a memory card/stick port, a High Definition Multimedia Interface (HDMI) port, and/or a headphone jack.

The notch 203 may also include various materials therein. For example, the notch 203 may have a film 245 therein. In one example, the film 245 may be a plastic flex film that surrounds and/or covers the antenna 243. For example, the film 245 may be between the antenna 243 and the unitary metal backplate 200 and/or between the antenna 243 and the display 254. In some embodiments, the film 245, such as the plastic flex film, may attach the antenna 243 to the unitary metal backplate 200 and/or to circuitry attached to the unitary metal backplate 200. The antenna 243 may additionally or alternatively have various types of covers, including various plastic and/or rubber covers. Such covers may, for example, minimize/reduce contact between the user of the unitary metal backplate 200 and the antenna 243.

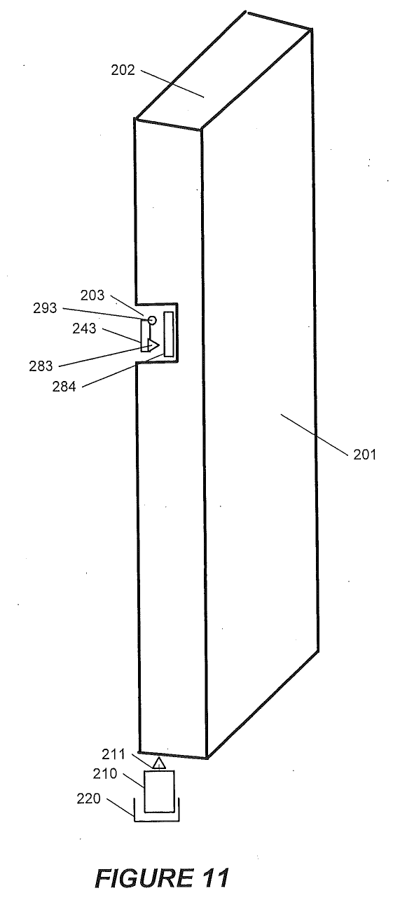

FIG. 11 illustrates the unitary metal backplate 200 including antenna feeding 283 and loading 293 structures according to some embodiments of the present invention. The feeding 283 and the loading 293 may be attached to the antenna 243 and may be within the notch 203. The loading 293 may be a tunable LC loading. Accordingly, the loading 293 may be adjusted to be provide a multi-band antenna for the antenna 243.

In some embodiments, the unitary metal backplate 200 is combined with the display 254, such as to provide the wireless terminal 20. In such embodiments, a material 284 may be between the feeding 283 and/or the loading 293 and the display 254 and/or the metal of the unitary metal backplate 200. For example, plastic may be between the feeding 283 and/or the loading 293 and the display 254 and/or the metal of the unitary metal backplate 200.

In some embodiments, the antenna 210 may have a feeding 211 attached thereto. For example, the feeding 211 of the antenna 210 and the feeding 283 of the antenna 243 may be positioned orthogonally to each other. Moreover, a polarization of the antenna 243 may be orthogonal to a polarization of the antenna 210.

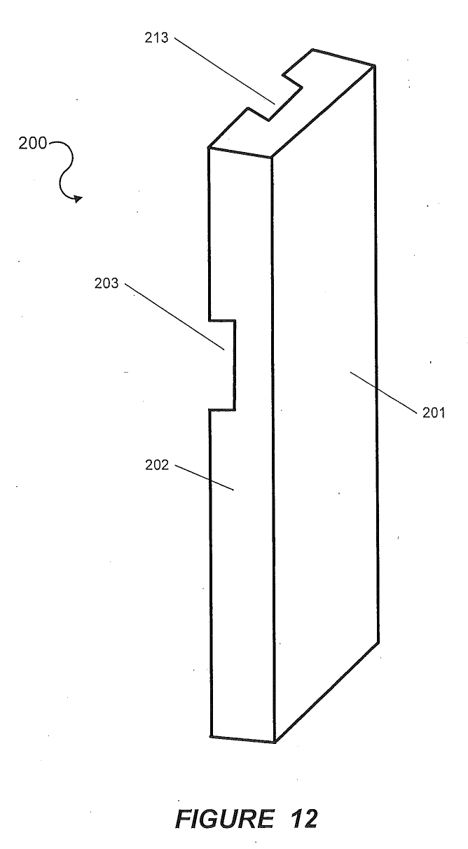

FIG. 12 illustrates the unitary metal backplate 200 including a plurality of notches 203, 213 according to some embodiments of the present invention. The notches 203, 213 are separated along the perimeter 202 by the metal of the unitary metal backplate 200. Additional notches may be included in the perimeter 202. For example, additional antennas may be desired, and a separate notch may be provided for each antenna in the unitary metal backplate 200. Moreover, in some embodiments, a notch may be included in the external face 201 of unitary metal backplate, additionally or alternatively to including notches in the perimeter 202.

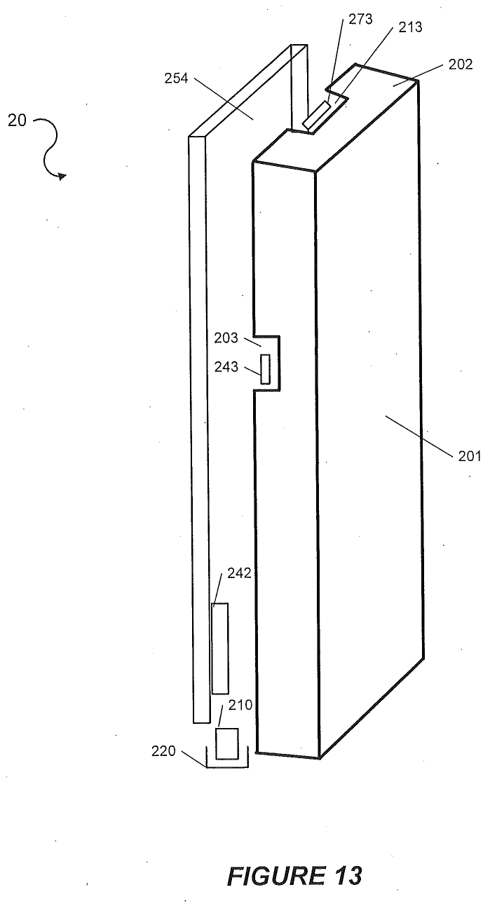

FIG. 13 illustrates the wireless terminal 20 including the unitary metal backplate 200 that includes the notches 203, 213 according to some embodiments of the present invention. The antenna 243 may be recessed within the notch 203, and an antenna 273 may be recessed within the notch 213. Accordingly, the antenna 243 and/or the antenna 273 may be between the display 254 and the unitary metal backplate 200.

A length of the notches 203, 213 may be the same or may be different. For example, the length of the notches 203, 213 may depend on the frequency band(s) of the antennas 243, 273 therein. In one example, the length of the notch 213 may be sized to accommodate the antenna 273 where the antenna 273 is configured to communicate GPS frequencies. Accordingly, the antenna 273 may be larger or smaller than the antenna 243, and the notch 213 may be larger or smaller than the notch 203. Additionally, the notch 213 may be sized to provide access to user-activated buttons and/or device ports.

In some embodiments, the notch 203 and/or the notch 213 may be at least approximately 1-2 millimeters wide. The length of the notch 203 and/or the notch 213 may be approximately a quarter wavelength of the corresponding antenna resonant frequency. For example, the length of the notch 203 and/or the notch 213 may be approximately 8 centimeters in some embodiments and may be approximately 4-5 centimeters in some highband embodiments.

In some embodiments, the antennas 210, 243, and 273 may be configured to resonate in different frequency bands, within the frequency bands for which the transceiver circuit 242 is configured, in response to different electromagnetic radiation. For example, the antenna 210 may be configured to communicate cellular frequencies, and the antenna 273 may be configured to communicate non-cellular frequencies. Moreover, one or more of the antennas 210, 243, and 273 may be multi-band antennas.

Referring still to FIG. 13, the notch 203 may be configured (i.e., positioned and/or sized) to emit communications from the antenna 243 and to minimize/reduce emitting communications from the antennas 210, 273. Additionally or alternatively, the notch 213 may be configured to emit communications from the antenna 273 and to minimize/reduce emitting communications from the antennas 210, 243. Moreover, the antenna 273 may be on an end of the unitary metal backplate 200 that is opposite the antenna 210. For example, the antenna 273 may be on a top end of the unitary metal backplate 200, and the antenna 210 may be on a bottom end of the unitary metal backplate 200.

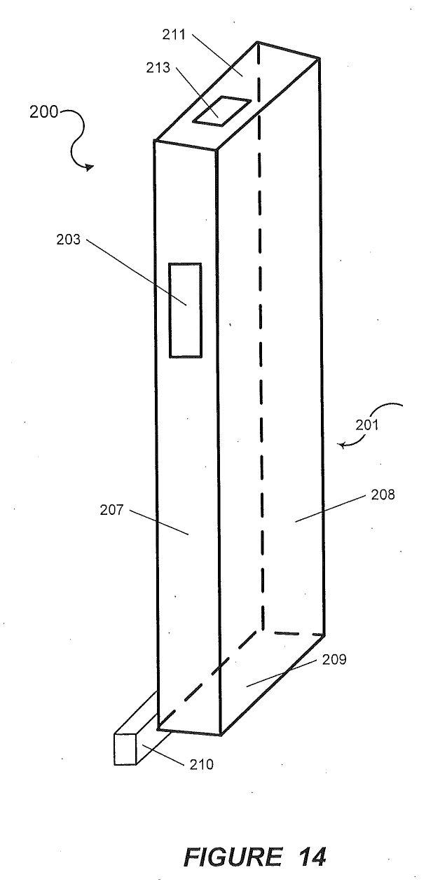

FIG. 14 illustrates the external face 201, sidewalls 207, 208, and ends 209, 211 of the unitary metal backplate 200 according to some embodiments of the present invention. One or more of the external face 201, the sidewalls, 207, 208, and the ends 209, 211 may include a notch. For example, although the notch 203 is illustrated in the sidewall 207 and the notch 213 is illustrated in the end 211, notches could additionally or alternatively be included in the external face 201, the sidewall 208, and/or the end 209.

The antenna 210 may be on the end 209 of the unitary metal backplate 200. For example, the external face 201 of the unitary metal backplate 200 may partially cover the antenna 210. Other portions (e.g., portions not covered by the unitary metal backplate 200) of the antenna 210 may extend beyond the end 209. Additionally, an antenna may be recessed in one or more of the notches 203, 213. The antenna 210 and/or the antennas in the notches 203, 213 may be multi-band antennas.

In some embodiments, the unitary metal backplate 200 may be solid metal. For example, with the exception of the notches 203, 213 and/or the void 206, the unitary metal backplate 200 may be solid metal (e.g., free of hollow portions) from the external face 201 to the internal face of the unitary metal backplate 200. Additionally, in some embodiments, the unitary metal backplate 200 may be substantially solid metal and may be shaped at the end 209 to receive the antenna 210 (e.g., a monopole antenna or a PIFA) and the non-metal cover 220.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed various embodiments and, although specific terms are employed, they are used in a generic and descriptive sense only and not for purposes of limitation.

What is claimed is:

1. A multi-band wireless communications terminal comprising:
a unitary metal backplate covering a multi-band transceiver circuit configured to provide communications for the multi-band wireless communications terminal via a plurality of frequency bands;
a notch in a perimeter of the unitary metal backplate;
a display opposing the unitary metal backplate such that the multi-band transceiver circuit is between the unitary metal backplate and the display;
a first antenna at least partially covered by a non-metal cover, the first antenna on an end of the unitary metal backplate, and the first antenna configured to resonate in a first frequency band within the plurality of frequency bands in response to first electromagnetic radiation; and
a second antenna recessed in the notch between the display and the unitary metal backplate, the second antenna configured to resonate in a second frequency band within the plurality of frequency bands in response to second electromagnetic radiation.

2. The multi-band wireless communications terminal of claim 1, wherein the non-metal cover includes plastic.

3. The multi-band wireless communications terminal of claim 1, wherein the notch is configured to provide access to user-activated buttons that are configured to control the multi-band wireless communications terminal.

4. The multi-band wireless communications terminal of claim 3, wherein the user-activated buttons include buttons configured to control at least one of volume, power, and imaging device functions.

5. The multi-band wireless communications terminal of claim 1, wherein the notch is configured to emit communications from the second antenna.

6. The multi-band wireless communications terminal of claim 5, wherein a width of the notch is approximately 1-2 millimeters and a length of the notch is approximately 4-8 centimeters.

7. The multi-band wireless communications terminal of claim 1, wherein the notch is configured to provide access to at least one of a Universal Serial Bus (USB) port and a device charging port.

8. The multi-band wireless communications terminal of claim 1, wherein the notch includes a tunable LC loading.

9. The multi-band wireless communications terminal of claim 1, wherein the first and second antennas are configured such that a polarization of the second antenna is orthogonal to a polarization of the first antenna.

10. The multi-band wireless communications terminal of claim 1, further comprising:
a second notch in the perimeter of the unitary metal backplate; and
a third antenna recessed in the second notch between the display and the unitary metal backplate, the third antenna configured to resonate in a third frequency band within the plurality of frequency bands in response to third electromagnetic radiation.

11. The multi-band wireless communications terminal of claim 10, wherein the second and third antennas are separated along the perimeter of the unitary metal backplate by metal.

12. The multi-band wireless communications terminal of claim 1, wherein the first antenna comprises a planar inverted-F antenna.

13. The multi-band wireless communications terminal of claim 1, wherein the unitary metal backplate includes a void sized for optics of an imaging device.

14. The multi-band wireless communications terminal of claim 10, wherein the third antenna is on a second end of the unitary metal backplate that is opposite the first antenna.

15. The multi-band wireless communications terminal of claim 14, wherein the first frequency band includes cellular frequencies and the third frequency band includes non-cellular frequencies.

16. The multi-band wireless communications terminal of claim 1, wherein the unitary metal backplate partially covers the first antenna such that a portion of the first antenna is between the display and the unitary metal backplate.

17. The multi-band wireless communications terminal of claim 1, wherein the first antenna comprises a first multi-band antenna and the second antenna comprises a second multi-band antenna.

18. A multi-band antenna system comprising:
a unitary metal backplate comprising a face, first and second sidewalls, and first and second ends;
a first notch in the first sidewall of the unitary metal backplate;
a second notch in one of the second sidewall of the unitary metal backplate and the second end of the unitary metal backplate;
a first antenna at least partially covered by a non-metal cover, the first antenna on the first end of the unitary metal backplate, the first antenna configured to resonate in a first frequency band in response to first electromagnetic radiation, and the first frequency band including cellular frequencies;
a second antenna recessed in the first notch, the second antenna configured to resonate in a second frequency band in response to second electromagnetic-radiation; and
a third antenna recessed in the second notch, the third antenna configured to resonate in a third frequency band in response to third electromagnetic radiation, and at least one of the second and third frequency bands including non-cellular frequencies.

19. The multi-band antenna system of claim 18, wherein the first antenna comprises a first multi-band antenna and one of the second and third antennas comprises a second multi-band antenna.

20. The multi-band antenna system of claim 18, wherein the face of the unitary metal backplate partially covers the first antenna.
